(19) United States
(12) Patent Application Publication
(10) Pub. No.: US 2012/0187107 A1
(43) Pub. Date: Jul. 26, 2012

(54) SYSTEM AND METHOD FOR CONTROLLING QUASI-RESONANT INVERTER AND ELECTRIC HEATING DEVICE EMPLOYING THE SAME

(75) Inventors: Yen-Ming LIU, Changhua County (TW); Yen-Chang CHEN, Taipei City (TW); Chun-Wei LIN, Tainan County (TW)

(73) Assignee: DELTA ELECTRONICS, INC., TAOYUAN HSIEN (TW)

(21) Appl. No.: 13/241,266

(22) Filed: Sep. 23, 2011

(30) Foreign Application Priority Data
Jan. 21, 2011 (TW) 100102424

(51) Int. Cl. H05B 1/02; H02M 7/537

(52) U.S. Cl. 219/492; 363/131

(57) ABSTRACT

A quasi-resonant inverter control system includes a mains zero-crossing detection circuit and a controller. The mains zero-crossing detection circuit is operable to detect a plurality of zero-crossing points of an input alternating-current voltage and output a zero-crossing detection signal based on the zero-crossing points. The controller is operable to control a plurality of burst mode period and receives the zero-crossing detection signal. Each of the burst mode periods includes a working duration and a non-working duration. Each of the working durations includes a start point and an end point. The controller is operable to determine the start points and the end points of the working durations based on the zero-crossing detection signal and outputs a control signal based on the start points and the end points of the working durations. An electric heating device and a method for controlling the quasi-resonant inverter are also disclosed herein.

### RELATED APPLICATIONS

This application claims priority to Taiwan Application Serial Number 100102424, filed Jan. 21, 2011, which is herein incorporated by reference.

### BACKGROUND

1. Field of Invention

The embodiment of the present invention relates generally to a control system and, more particularly, to a system for controlling a quasi-resonant inverter.

2. Description of Related Art

Heating of induction cookers is achieved by the principle of the electromagnetic coupling which transduces an electric energy into a magnetic energy that is then transduced to generate a heat energy; thereafter, the heat energy is transferred to the load to provide induction heating. As opposed to other forms of heating, there is no fire produced and no petrochemical ingredient used during the induction heating process. As such, the induction cooker is a safer as well as a more environmental-friendly heating device.

Specifically, the circuit of the induction cooker employs a high frequency power switch which, in conjunction with a quasi-resonant inverter framework and a switch controlling technology, is operable to transduce the direct current into a high frequency alternating current and then transduce the alternating current into an alternating magnetic field. When an electrically conductive pot is brought close to the cooking surface of the induction cooker, the magnetic field induces an eddy current in the pot. The content within the pot is heated by Joule loss, which is caused by the flow of the eddy current through the pot.

The above mentioned resonant inverter plays an important role in the inductor cooker. There are two sorts of inverters used for the induction cooker. One is a half-bridge inverter, and the other is a quasi-resonant inverter. Both of these inverters use a coil and a capacitor to form L-C oscillation for generating the high frequency alternating current, wherein the quasi-resonant inverter is more cost-effective because it only requires one power switch.

However, in quasi-resonant type induction cookers, the oscillation of the pot would generate an annoying noise whenever the induction cooker is turned on or turned off. This is because of the abrupt change of the magnetic field in the coil. Some prior attempts aim at increasing the duration of the pulse cycle so as to mitigate the discomfort experienced by the user. However, extending the duration of the pulse cycle may significantly change the temperature of the pot thereby decrease the heating efficiency of the induction cooker.

In view of the foregoing, there is still room for improvement regarding the control of the quasi-resonant type induction cooker.

### SUMMARY

A quasi-resonant inverter control system is provided so as to improve the problem of the pot noise caused by the abrupt change of the magnetic field in the coil and avoid the significant variation of the temperature of the pot due to the extended duration of the pulse cycle.

Thus, one aspect of the embodiment of the present invention is to provide a quasi-resonant inverter control system. The quasi-resonant inverter control system comprises a mains zero-crossing detection circuit, a controller, and a power switch driver circuit.

The mains zero-crossing detection circuit detects a plurality of zero-crossing points of an input alternating-current voltage to output a zero-crossing point detection signal based on the zero-crossing points. The controller controls a plurality of pulse cycles, wherein each of the pulse cycles comprises a working duration and a non-working duration, and each of the working durations comprises a start point and an end point; the controller receives the zero-crossing point detection signal to determine the start points and the end points of the working durations based on the zero-crossing point detection signal and generates a control signal based on the start points and the end points of the working durations. The power switch driver circuit is electrically connected to the controller wherein the power switch driver circuit is operable to receive the control signal to control the quasi-resonant inverter.

In one embodiment of the present invention, the working durations comprise a plurality of switching cycles each having a duty cycle, and the controller is operable to control the duty cycles so that the duty cycles becomes gradually increase.

In another embodiment of the present invention, the mains zero-crossing detection circuit comprises a power switch. The power switch comprises a control terminal, a first terminal, and a second terminal. The control terminal controls the power switch based on an input alternating-current voltage. The first terminal outputs the zero-crossing point detection signal. The second terminal is electrically connected to a ground terminal. In addition, the control terminal turns on the power switch during the positive half cycle of the input voltage and turns off the power switch during the negative half cycle of the input voltage.

In another aspect, the embodiment of the present invention provides an electric heating device. The electric heating device comprises a quasi-resonant inverter and a quasi-resonant inverter control system. The quasi-resonant inverter transduces a direct-current voltage into a high frequency alternating-current voltage.

The quasi-resonant inverter control system comprises a mains zero-crossing detection circuit, a controller, and a power switch driver circuit. The mains zero-crossing detection circuit detects a plurality of zero-crossing points of an input alternating-current voltage and outputs a zero-crossing point detection signal. The controller controls a plurality of pulse cycles, wherein each of the pulse cycles comprises a working duration and a non-working duration, and each of the working duration comprises a start point and an end point; the controller receives the zero-crossing point detection signal to determine the start points and the end points of the working durations based on the zero-crossing point detection signal and generates a control signal based on the start points and the end points of the working durations. The power switch driver circuit is electrically connected to the controller wherein the power switch driver circuit is operable to receive the control signal to control the quasi-resonant inverter

In one embodiment of the present invention, the working durations comprise a plurality of switching cycles, and the controller is operable to control the duty cycles of each of the switching cycles so that the duty cycles gradually increase.

In another embodiment of the present invention, the mains zero-crossing detection circuit comprises a power switch. The power switch comprises a control terminal, a first terminal, and a second terminal. The control terminal switches the power switch based on an input alternating-current voltage. The first terminal outputs the zero-crossing point detection signal. The second terminal is electrically connected to a ground terminal. In addition, the control terminal turns on the power switch during the positive half cycle of the input voltage and turns off the power switch during the negative half cycle of the input voltage.

In yet another embodiment of the present invention, the electric heating device further comprises a rectifier circuit and a filter circuit. The rectifier circuit transduces the alternating-current voltage into the direct-current voltage. The filter circuit filters a high frequency voltage ripple generated by the quasi-resonant inverter.

In still another embodiment of the present invention, the electric heating device further comprises an electromagnetic interference filter. The electromagnetic interference filter suppresses the electromagnetic interference noise generated by the quasi-resonant inverter working in a high frequency.

In yet another aspect, the embodiment of the present invention provides a method for controlling a quasi-resonant inverter. The method for controlling a quasi-resonant inverter comprises the steps of: detecting a plurality of zero-crossing points of an input alternating-current voltage to generate a zero-crossing point detection signal and determining a start point and an end point of a working duration of a plurality of pulse cycles based on the zero-crossing point detection signal; generating a switching signal based on the start points and the end points of the working durations; and controlling the quasi-resonant inverter based on the switching signal.

In one embodiment of the present invention, the method for controlling a quasi-resonant inverter further comprises the step of: controlling a duty cycle of a plurality of switching cycles of each of the working durations so that each of the duty cycles gradually increase.

In summary, the embodiments of the present invention provide a quasi-resonant inverter control system so as to improve the problem of the pot noise caused by the abrupt change of the magnetic field in the coil and avoid the significant variation of the temperature of the pot due to the extended period of the pulse cycle. As such, the quasi-resonant inverter control systems in accordance with the embodiments of the present invention can decrease the noise generated by the operation of the quasi-resonant inverter of the pot during the pulse cycle as well as provide better heating efficiency.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 schematically shows a block diagram of an electric heating device according to one embodiment of the present invention;

FIG. 2 schematically shows a circuit block diagram of the electric heating device according to another embodiment of the present invention;

FIG. 3 schematically shows a circuit of a mains zero-crossing detection circuit according to yet another embodiment of the present invention;

FIG. 4 schematically shows a timing diagram of an input alternating-current voltage, a zero-crossing point detection signal, a DC-link voltage, and a quasi-resonant inverter pulse cycle according to still another embodiment of the present invention;

FIG. 5 schematically shows a diagram of the pulse cycle of the quasi-resonant inverter according to FIG. 4; and

FIG. 6 is a flow chart illustrating a method for controlling the quasi-resonant inverter according to still anther embodiment of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

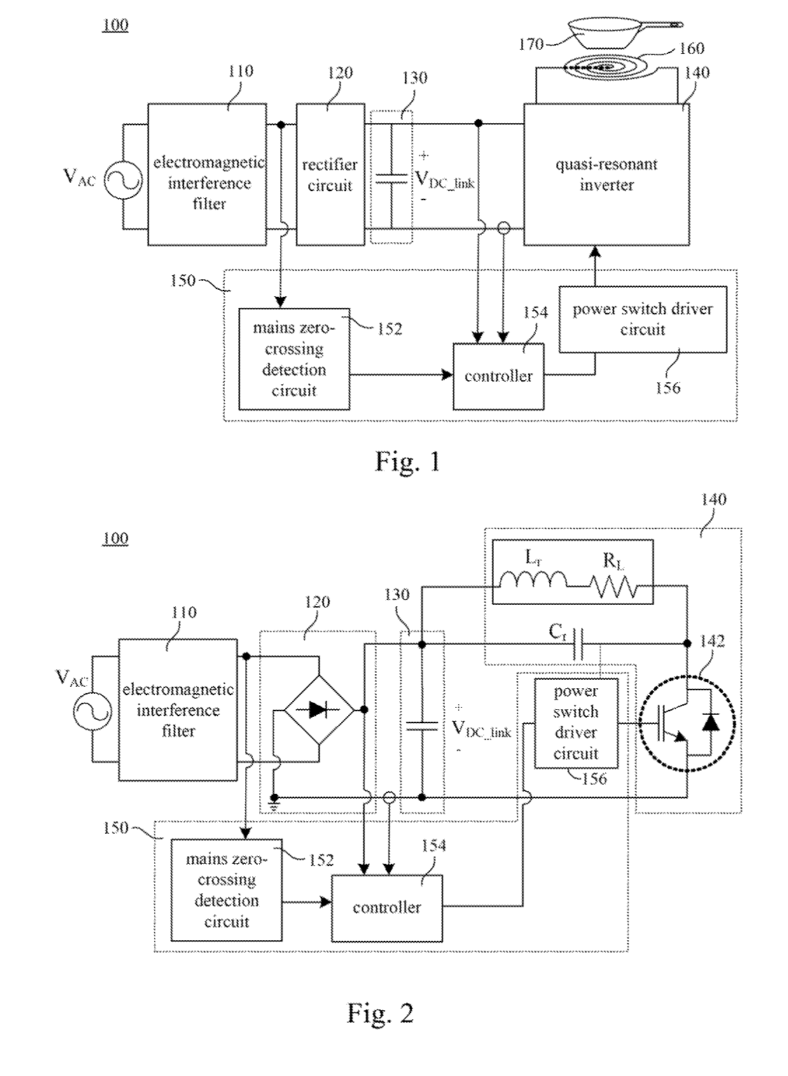

FIG. 1 schematically shows a block diagram of an electric heating device 100 according to one embodiment of the present invention. The electric heating device 100 comprises an electromagnetic interference filter 110, a rectifier circuit 120, a filter circuit 130, a quasi-resonant inverter 140, and a quasi-resonant inverter control system 150.

In practical, the electromagnetic interference filter 110 suppresses an electromagnetic interference noise generated by the quasi-resonant inverter 140 working in a high frequency. The rectifier circuit 120 is electrically connected to the electromagnetic interference filter 110 and transduces an alternating-current voltage VAC into a direct-current voltage VDC_link. The filter circuit 130 reduces a high frequency voltage ripple generated by the quasi-resonant inverter 140. The quasi-resonant inverter 140 transduces the direct-current voltage VDC_link into a high frequency alternating-current voltage. When the high frequency alternating-current current flows through a coil 160, the alternating magnetic field is generated thus an eddy current occurs on the surface of the pot 170 so that Joule loss generated by the pot 170 can be used to heat foods or water.

Particularly, as shown in FIG. 2 which schematically shows a circuit block diagram of the electric heating device 100 according to another embodiment of the present invention. The rectifier circuit 120 may be a center-tapped full wave rectifier circuit or a bridge-type full wave rectifier circuit composed of diodes. The filter circuit 130 may be a capacitor or a combination of inductors and capacitors, and it not only can reduce the high frequency voltage ripple but stabilize a VDC_link. The coupling between the coil 160 and the pot 170 in FIG. 1 is modeled as the series connection of an inductor Lr and a resistor RL in FIG. 2. So, the quasi-resonant inverter 140 comprises the equivalent inductance Lr, the equivalent resistance RL of a pot, capacitor Cr, and a power switch 142. After the equivalent inductance Lr and the equivalent resistance RL of the pot are connected in series, they are connected with the capacitor Cr in parallel to form a L-C oscillating circuit; and in accordance with the power switch 142, the quasi-resonant inverter 140 may transduce the direct-current voltage VDC_link into the high frequency alternating-current voltage.

The principle of the electric heating device is as mentioned above; however, every time the quasi-resonant type electric heating device is activated or shut down, the pot 170 vibrates and generates an annoying noise due to the abrupt change of the magnetic field in the coil. As a result, the embodiment of the present invention provides a quasi-resonant inverter control system 150 so as to improve the existing problem.

Reference is now made to FIG. 1 or FIG. 2, the quasi-resonant inverter control system 150 comprises a mains zero-crossing detection circuit 152, a controller 154, and a power switch driver circuit 156.

Particularly, the mains zero-crossing detection circuit 152 detects a plurality of zero-crossing points of an input alternating-current voltage VAC and outputs a zero-crossing point detection signal based on the zero-crossing points. The controller 154 controls a plurality of pulse cycles, wherein each of the pulse cycles comprises a working duration and a non-working duration, and each of the working durations comprises a start point and an end point; the controller 154 receives the zero-crossing point detection signal to determine the start points and the end points of the working durations based on the zero-crossing point detection signal and generates a control signal based on the start points and the end points of the working durations. The power switch driver circuit 156 may be electrically connected to the quasi-resonant inverter 140 and the controller 154 wherein the power switch driver circuit 156 is operable to receive the control signal to control the quasi-resonant inverter 140.

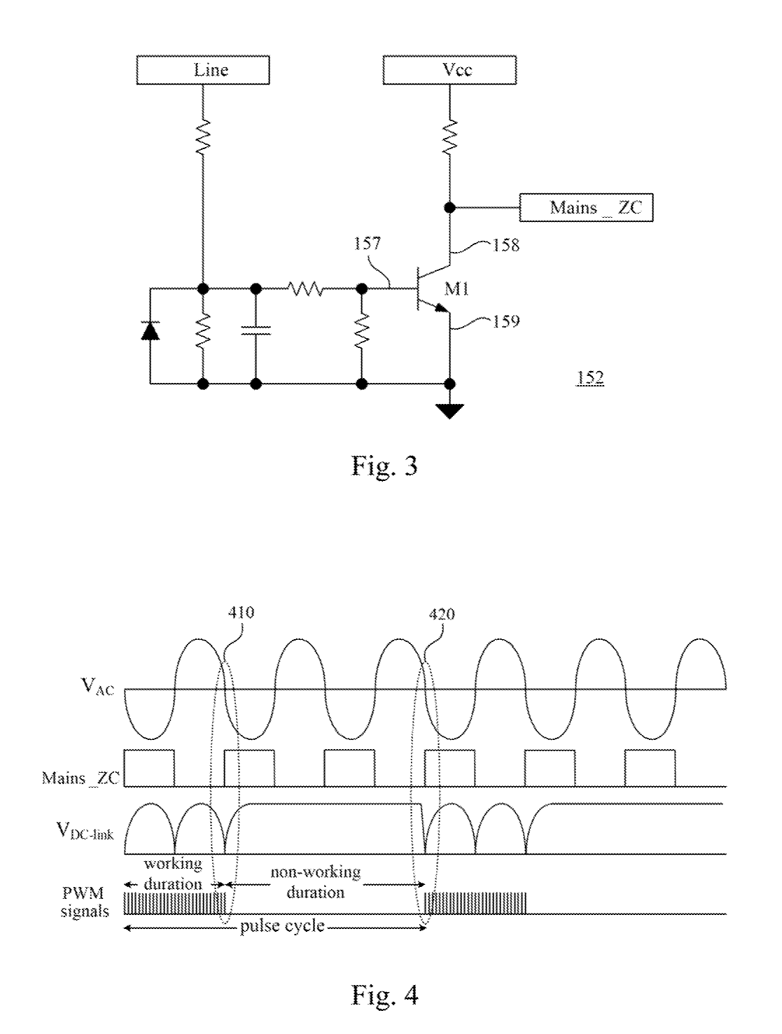

For the mains zero-crossing detection circuit 152 as shown in FIG. 3, the mains zero-crossing detection circuit 152 comprises a power switch M1. The power switch M1 comprises a control terminal 157, a first terminal 158, and a second terminal 159. In addition, the Line terminal of the mains zero-crossing detection circuit 152 is connected to line or neutral terminal of the input voltage VAC, and the Vcc terminal of the mains zero-crossing detection circuit 152 is connected to a high level voltage.

In this embodiment, the control terminal 157 controls the power switch M1 based on the input voltage VAC. In detail, the input voltage VAC the Line terminal of the mains zero-crossing detection circuit 152 receives may be divided by a voltage divider, and the divided voltage of the alternating-current voltage VAC is provided to the control terminal 157 to control the power switch M1. However, the scope of the present application is not intended to be limited to the embodiment, it should be understood by those skilled in the art that only if the power switch M1 can be controlled accurately, the control terminal 157 may use all sorts of the alternating-current voltage VAC.

Moreover, the first terminal 158 outputs the zero-crossing point detection signal Mains_ZC. The second terminal 159 is electrically connected to a ground terminal.

In practical, the control terminal 157 turns on the power switch M1 during the positive half cycle of the alternating-current voltage VAC, and the zero-crossing point detection signal Mains_ZC outputted by the first terminal 158 is a low level signal. The control terminal 157 turns off the power switch M1 during the negative half cycle of the alternating-current voltage, and the zero-crossing point detection signal Mains_ZC outputted by the first terminal 158 is a high level signal.

Therefore, the mains zero-crossing detection circuit 152 controls the power switch M1 to be turned on or turned off based on the alternating-current voltage VAC to detect a plurality of zero-crossing points, and the first terminal 158 outputs the zero-crossing point detection signal Mains_ZC.

Reference is now made to FIG. 4 which schematically shows a timing diagram of the input alternating-current voltage, the zero-crossing point detection signal, the DC-link voltage, and the quasi-resonant inverter pulse cycle according to still another embodiment of the present invention.

As shown in FIG. 4, the quasi-resonant inverter 140 is controlled by a plurality of pulse cycles, wherein each of the working durations of the pulse cycles comprises a start point 420 and an end point 410. When the zero-crossing point detection signal Mains_ZC is switched between a high level and a low level, the start point 420 and the end point 410 of the working duration will be triggered so that the start point 420 and the end point 410 is corresponding to the zero-crossing point; that is to say, the start point 420 and the end point 410 of the working durations are determined by the zero-crossing point detection signal Mains_ZC.

In view of the foregoing, the controller 154 can generate control signal based on the start point 420 and the end point 410 of the working durations. As shown in FIG. 4, for example, the pulse cycle of the quasi-resonant inverter 140 is triggered by the zero-crossing point detection signal Mains_ZC and is stopped by the zero-crossing point detection signal Mains_ZC after three periods of the alternating-current voltage VAC. Moreover, there is one period of the alternating-current voltage VAC, which belongs to the working duration; and there are two periods of the alternating-current voltage VAC, which belong to the non-working duration in the pulse cycle of the quasi-resonant inverter 140.

As mentioned above, the duty cycles gradually increase so that the instant input voltage of the quasi-resonant inverter 140 becomes smaller to reduce the changing of the magnetic field in the coil 160 due to using the zero-crossing point of the alternating-current voltage VAC (or the DC-link voltage VDC_link) as the start point 420 and the end point 410 of the working duration and the duty cycle of the switching cycles in each of the working durations can be controlled based on the start point of the working durations. As a result, the problem of the pot 170 noise caused by abrupt change of the magnetic field in the coil 160 can be improved.

In addition, the embodiment of the present invention doesn't introduce the solvent in the prior art; that is to say, the embodiment of the present invention doesn't increase the pulse cycle to mitigate the discomfort experienced by the user. Therefore, compared with the prior art, the embodiment of the present invention can avoid significant variation of the temperature of the pot 170 due to the extended duration of the pulse cycle so that the embodiment of the present invention can decrease the noise of the pot 170 generated by the quasi-resonant inverter 140 when turning on and turning off itself and provide better heating efficiency.

The power switch driver circuit 156 as shown in FIG. 1 may be electrically connected to the quasi-resonant inverter 140; particularly, the power switch driver circuit 156 as shown in FIG. 2 may be electrically connected to the power switch 142 in the quasi-resonant inverter 140. The power switch driver circuit 156 receives the control signal generated by the controller 154 to control the switching of the power switch 142 in the quasi-resonant inverter 140. In one embodiment, the control signal generated by the controller 154 may be a pulse width modulation (PWM) signal.

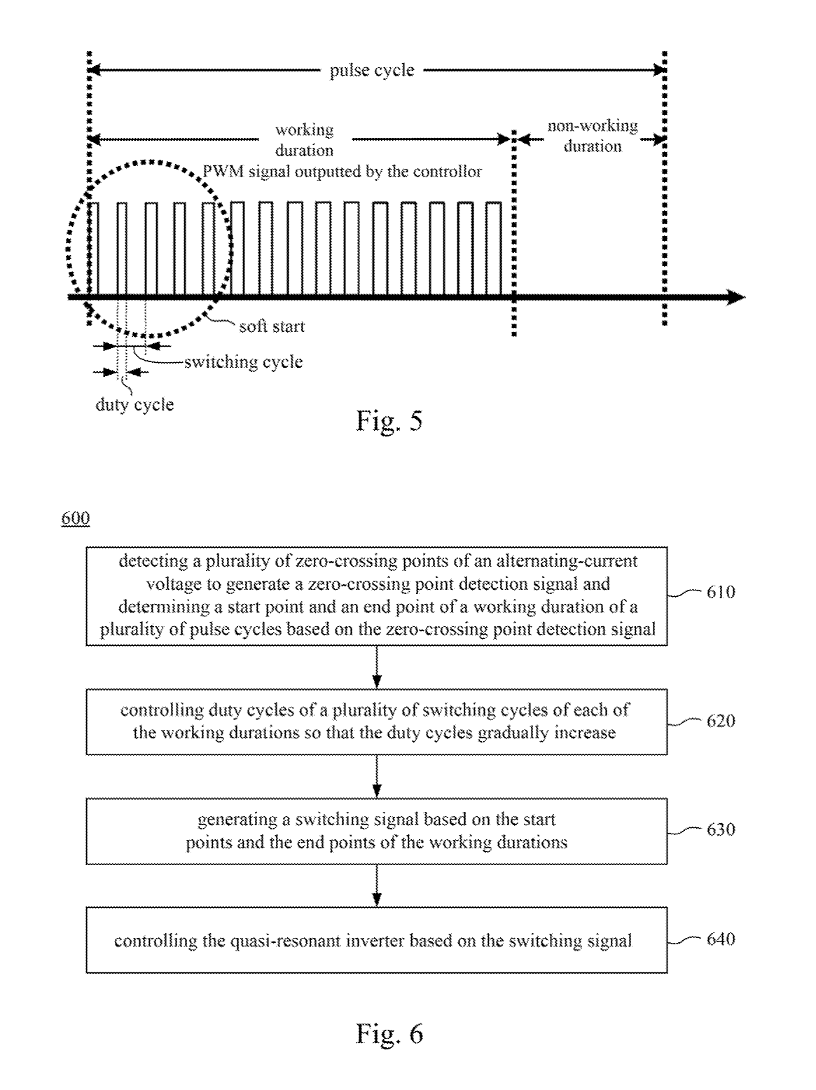

FIG. 5 schematically shows a diagram of the pulse cycle of the quasi-resonant inverter according to FIG. 4. Reference is now made to FIG. 5, the pulse cycle of the quasi-resonant inverter 140 comprises the working duration and the non-working duration, wherein the working duration further comprises a plurality of switching cycles each having a dusty cycle.

The controller 154 controls the duty cycles so that the duty cycles gradually increase from the start point of the working duration; that is to say, a soft start is introduced. As a result, the magnetic field of the coil 160 may be gradually increased so as to reduce the noise generated by the pot 170.

FIG. 6 schematically shows a flow chart illustrating of a method 600 for controlling the quasi-resonant inverter according to still another embodiment of the present invention. The method 600 for controlling a quasi-resonant inverter comprises the steps of detecting a plurality of zero-crossing points of an alternating-current voltage to generate a zero-crossing point detection signal and determining a start point and an end point of a working duration of a plurality of pulse cycles based on the zero-crossing point detection signal (step 610).

In step 610, the mains zero-crossing detection circuit 152 as shown in FIG. 3 may be implemented to detect a plurality of zero-crossing points to generate a zero-crossing point detection signal. Furthermore, the controller 154 as shown in FIG. 1 may be implemented to determine a start point and an end point of a working duration based on the zero-crossing point detection signal.

In detail, as shown in FIG. 4, when the zero-crossing point detection signal Mains_ZC is switched between a high level and a low level, the start point 420 and the end point 410 of the working duration will be triggered so that the start point 420 and the end point 410 is corresponding to the zero-crossing point; that is to say, the start point 420 and the end point 410 of the working durations is determined by the zero-crossing point detection signal.

As a result, the zero-crossing point of the alternating-current voltage VAC (also the zero-crossing point of the DC-link voltage VDC_link) is used as the start point 420 and the end point 410 so as to reduce the change of the magnetic field in the coil 160 due to the quasi-resonant inverter 140 implementing in a smaller input voltage.

Next, after determining the start point and the end point of the working durations, the method 600 further comprises the steps of controlling duty cycles of a plurality of switching cycles of each of the working durations so that the duty cycles gradually increase (step 620); generating a switching signal based on the start points and the end points of the working durations (step 630); then, controlling the quasi-resonant inverter based on the switching signal (step 640). As a result, the problem of the pot 170 noise caused by abrupt change of the magnetic field in the coil 160 can be improved.

In step 620, the controller 154 may be implemented to control the duty cycles of switching cycles of each of the working durations so that the duty cycles gradually increase; particularly, a soft start has been implemented with the controller 154. As a result, the magnetic field of the coil 160 may be gradually increased so as to reduce the noise generated by the pot 170.

Moreover, in step 630, the controller 154 may be implemented to generate a switching signal based on the start points and the end points of the working durations; then, in step 640, the power switch driver circuit 156 as shown in FIG. 1 may be implemented to control the quasi-resonant inverter 140 based on the switching signal.

In view of the foregoing embodiments of the present invention, many advantages of the present invention are now apparent. The embodiment of the present invention provides a quasi-resonant inverter control system 150 so as to improve the problem of the pot 170 noise caused by abrupt change of the magnetic field in the coil 160 and avoid the significant variation of the temperature of the pot 170 due to the extended period of the pulse cycle in prior art so that the embodiment of the present invention can decrease the noise generated by the operation of the quasi-resonant inverter of the pot during the pulse cycle and achieve the aim of keeping warm better.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A quasi-resonant inverter control system, comprising:
a mains zero-crossing detection circuit for detecting a plurality of zero-crossing points of an input alternating-current voltage to output a zero-crossing point detection signal based on the zero-crossing points;
a controller for controlling a plurality of pulse cycles, wherein each of the pulse cycles comprises a working duration and a non-working duration, and each of the working durations comprises a start point and an end point; the controller receives the zero-crossing point detection signal to determine the start points and the end points of the working durations based on the zero-crossing point detection signal and generates a control signal based on the start points and the end points of the working durations; and
a power switch driver circuit electrically connected to the controller wherein the power switch driver circuit is operable to receive the control signal to control the quasi-resonant inverter.

2. The quasi-resonant inverter control system according to claim 1, wherein the working durations comprise a plurality of switching cycles each having a duty cycle, and the controller is operable to control the duty cycles so that the duty cycles gradually increase.

3. The quasi-resonant inverter control system according to claim 1, wherein the mains zero-crossing detection circuit comprises:
a power switch comprising:
a control terminal for controlling the power switch based on an input alternating-current voltage;
a first terminal for outputting the zero-crossing point detection signal; and
a second terminal electrically connected to a ground terminal,
wherein the control terminal turns on the power switch during the positive half cycle of the input voltage and turns off the power switch during the negative half cycle of the input voltage.

4. An electric heating device, comprising:
a quasi-resonant inverter for transducing a direct-current voltage into a high frequency alternating-current voltage; and
a quasi-resonant inverter control system comprising:
a mains zero-crossing detection circuit for detecting a plurality of zero-crossing points of an input alternating-current voltage and outputting a zero-crossing point detection signal;
a controller for controlling a plurality of pulse cycles, wherein each of the pulse cycles comprises a working duration and a non-working duration, and each of the working duration comprises a start point and an end point; the controller receives the zero-crossing point detection signal to determine the start points and the end points of the working durations based on the zero-crossing point detection signal and generates a control signal based on the start points and the end points of the working durations; and
a power switch driver circuit electrically connected to the controller, wherein the power switch driver circuit is operable to receive the control signal to control the quasi-resonant inverter.

5. The electric heating device according to claim 4, wherein the working durations comprise a plurality of switching cycles, and the controller is operable to control the duty cycles of each of the switching cycles so that the duty cycles gradually increase.

6. The electric heating device according to claim 4, wherein the mains zero-crossing detection circuit comprises:
a power switch comprising:
a control terminal for switching the power switch based on an input alternating-current voltage;
a first terminal for outputting the zero-crossing point detection signal; and
a second terminal electrically connected to a ground terminal,
wherein the control terminal turns on the power switch during the positive half cycle of the input voltage and turns off the power switch during the negative half cycle of the input voltage.

7. The electric heating device according to claim 4, further comprising:
a rectifier circuit for transducing the alternating-current voltage into the direct-current voltage; and
a filter circuit for filtering a high frequency voltage ripple generated by the quasi-resonant inverter.

8. The electric heating device according to claim 4, further comprising:
an electromagnetic interference filter for suppressing an electromagnetic interference noise generated by the quasi-resonant inverter operating with a high frequency.

9. A method for controlling a quasi-resonant inverter, comprising the steps of:
detecting a plurality of zero-crossing points of an input alternating-current voltage to generate a zero-crossing point detection signal and determining a start point and an end point of a working duration of a plurality of pulse cycles based on the zero-crossing point detection signal;
generating a switching signal based on the start points and the end points of the working durations; and
controlling the quasi-resonant inverter based on the switching signal.

10. The method according to claim 9, further comprising the step of:
controlling a duty cycle of a plurality of switching cycles of each of the working durations so that the duty cycles gradually increase.
